(19) United States
(12) Patent Application Publication
(10) Pub. No.: US 2016/0026635 A1
(43) Pub. Date: Jan. 28, 2016

(54) SYSTEM AND METHOD FOR DETERMINING LIFE CYCLE INTEGRITY OF KNOWLEDGE ARTIFACTS

(71) Applicant: Wipro Limited, Bangalore (IN)

(72) Inventors: Sreenivas Kunapuli, Hyderabad (IN); Anuradha Pentareddy, Hyderabad (IN)

(21) Appl. No.: 14/483,316

(22) Filed: Sep. 11, 2014

(30) Foreign Application Priority Data
Jul. 24, 2014 (IN) 3610/CHE/2014

(51) Int. Cl. G06F 17/30; H04L 12/851

(52) U.S. Cl. CPC G06F 17/3053; H04L 47/2425

(57) ABSTRACT

The present disclosure relates to a method, knowledge management computing device, and a non-transitory computer readable medium for determining lifecycle integrity of one or more knowledge artifacts. In one embodiment, life cycle integrity is determined by determining one or more parameters such as technology governance index, process governance index, corporate governance index, future change governance index of the knowledge artifacts. By determining the life cycle integrity of the knowledge artifacts, the system is able to continuously monitor and record the changes happening during the life cycle of the knowledge artifacts and also implements definite controls, checks and balances in the knowledge management. Further, the Knowledge management system is capable of adapting itself to the future changes or needs and also ensuring that the processes are being followed in line with standard protocols followed on the Knowledge trade.

This application claims the benefit of Indian Patent Application Serial No. 3610/CHE/2014 filed Jul. 24, 2014, which is hereby incorporated by reference in its entirety.

### FIELD

The present subject matter is related, in general to knowledge management system, and more particularly, but not exclusively to a method and a system for determining life cycle integrity index of knowledge artifacts.

### BACKGROUND

Knowledge Management comprises a range of practices used by organizations to identify, create, represent, and distribute knowledge. Knowledge Management (KM) programs are typically tied to organizational objectives such as improved performance, competitive advantage, innovation, developmental processes, and the general development of collaborative practices. Knowledge management typically utilizes KM applications (e.g. software applications) to categorize, store, and search knowledge artifacts.

Knowledge artifacts are records of information, such as documents, that exist in a retrievable format for use by others. A knowledge artifact may be any memorialization (i.e. record) of information, such as, by way of non-limiting examples, a document, an audio recording, or a video recording. Information can be obtained from documents, interviews, or any other source. Knowledge is often captured and fragmented across a set of digital artifacts or files such as text files, images, binaries, source code, proprietary application files, and others. KM applications are generally usable to search for and retrieve records of knowledge artifacts so that they may be re-used or serve as examples for future reference. However, conventional KM applications do not continuously evaluate the knowledge artifacts and foresee the future changes that the knowledge artifacts may undergo.

Therefore, there is a need to provide a method and a system to record the changes that the knowledge artifacts undergo throughout its lifecycle from the creation till retire of the knowledge artifacts.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a computer-implemented method of determining lifecycle integrity of one or more knowledge artifacts. The method comprises accessing at least one metadata associated with the one or more knowledge artifacts. Using the at least one metadata of the one or more knowledge artifacts, at least one of a technology governance index score, a process governance index score, a corporate governance index score, and a future change index score is determined. The method further comprises determining a life cycle integrity index score of the one or more knowledge artifacts based on the at least one of technology governance index score, the process governance index score, the corporate governance index score and the future change index score.

Further, the present disclosure relates to a computer-implemented system for determining life cycle integrity of one or more knowledge artifacts. The system comprises a memory communicatively coupled to the processor, wherein the memory stores processor-executable instructions, which, on execution, causes the processor to determine at least one of a technology governance index score, a process governance index score, a corporate governance index score, and a future change index score using at least one metadata of the one or more knowledge artifacts. Further, the instructions, on execution, further cause the processor to determine a life cycle integrity index score of the one or more knowledge artifacts based on the at least one of technology governance index score, the process governance index score, the corporate governance index score and the future change index score.

Furthermore, the present disclosure relates to a non-transitory computer readable medium including instructions stored thereon that when processed by at least one processor cause a system to perform the acts of accessing at least one metadata associated with the one or more knowledge artifacts. Further, the instructions cause the processor to perform the acts of determining at least one of a technology governance index score, a process governance index score, a corporate governance index score, and a future change index score using the at least one metadata of the one or more knowledge artifacts. Furthermore, the instructions cause the processor to perform the acts of determining a life cycle integrity index score of the one or more knowledge artifacts based on the at least one of technology governance index score, the process governance index score, the corporate governance index score and the future change index score.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates architecture of system for determining life cycle integrity index of knowledge artifacts in accordance with some embodiments of the present disclosure;

FIG. 2 illustrates a block diagram of a life cycle integrity governance unit for determining life cycle integrity index of the knowledge artifacts in accordance with some embodiments of the present disclosure;

FIG. 3 illustrates a flowchart of a method of determining life cycle integrity index of the knowledge artifacts in accordance with some embodiments of the present disclosure;

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a computer-implemented method and a system for determining lifecycle integrity of one or more knowledge artifacts. In one embodiment, life cycle integrity is determined by determining one or more parameters such as technology governance index, process governance index, corporate governance index, future change governance index of the knowledge artifacts. By determining the life cycle integrity of the knowledge artifacts, the system is able to continuously monitor and record the changes happening during the life cycle of the knowledge artifacts and also implements definite controls, checks and balances in the knowledge management. Further, the Knowledge management system is capable of adapting itself to the future changes or needs and also ensuring that the processes are being followed in line with standard protocols followed on the Knowledge trade.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

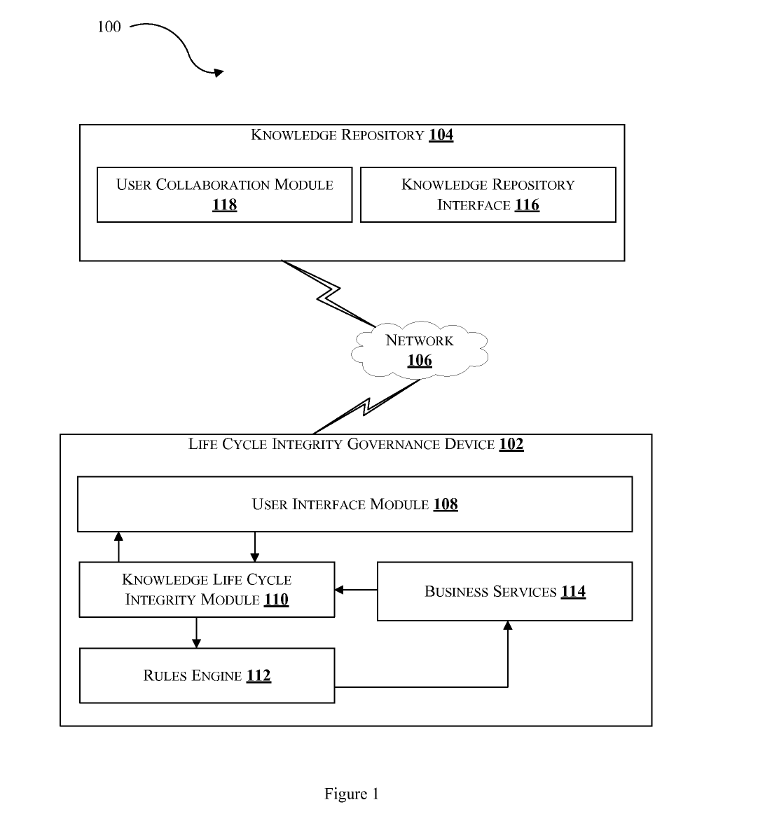

FIG. 1 illustrates architecture of system for determining life cycle integrity index of knowledge artifacts in accordance with some embodiments of the present disclosure.

As shown in FIG. 1, a system 100 for determining life cycle integrity index of knowledge artifacts comprises one or more components coupled with each other. In one implementation, the system 100 comprises a life cycle integrity governance device 102 (hereinafter referred to as governance device 102) communicatively coupled with a knowledge repository 104 via a communication network 106.

The knowledge repository 104 refers to an electronic storage system that stores knowledge artifacts and dependencies for later retrieval. The stored knowledge artifacts are published in accordance with procedures which are well known to those in the field, so that artifacts made by one developer are published to be available for further use by other developers. The stored knowledge artifacts are incorporated as building blocks to build products which can be executed. In one embodiment, the knowledge repository 104 can include a computer server by which the stored electronic copies of 104 knowledge artifacts are made available for use by developers to be incorporated as building blocks to build products which can be executed. The knowledge repository 104 has a unique identifier that indicates the developer (an individual or a group) that contributed the artifact. The knowledge repository 104 can be remote or local.

The knowledge repository 104 comprises a knowledge repository interface 116 to enable the governance device 102 to access the one or more knowledge artifacts stored in the knowledge repository 104. In one embodiment, the knowledge repository interface 116 provides user interface to one or more services provided by the knowledge repository 104. Example of services include Application services, Search services, Personalization services, Publishing services, Security and Infra services, and Notification services. The knowledge repository 104 also comprises a user collaboration module 118 configured to enable the users to collaborate on the one or more stored knowledge artifacts. The user collaboration module 118 update one or more modified or new knowledge artifacts in the knowledge repository 104 obtained during the user collaboration so that the governance device 102 access the one or more updated knowledge artifacts to determine the life cycle integrity of the updated knowledge artifacts.

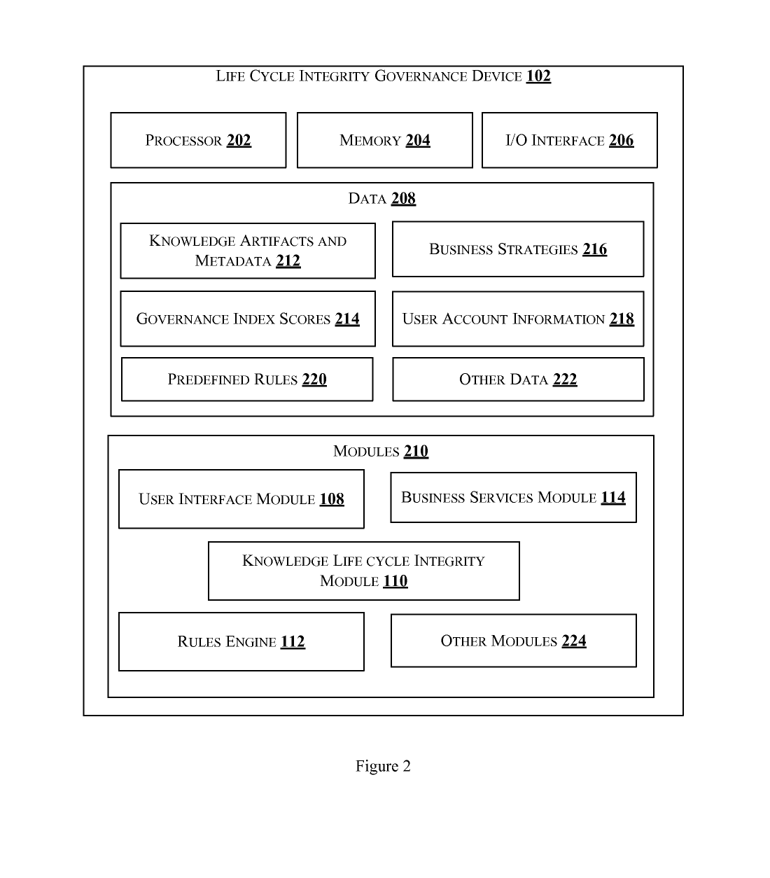

In one embodiment, the governance device 102 comprises a user interface module 108, a knowledge life cycle integrity module 110, a rules engine 112 and a business services module 114. The governance device 102 is one of the possible variations of the governance device 102 described in greater details below with reference to FIG. 2. In one implementation, the governance device 102, as shown in FIG. 2, includes a central processing unit (“CPU” or “processor”) 202, a memory 204 and an I/O interface 206. The interface 206 is coupled with the processor 202 and an I/O device. The I/O device is configured to receive inputs via the I/O interface 206 and transmit outputs for displaying in the I/O device via the I/O interface 206.

The governance device 102 further comprises data 208 and modules 210. In one implementation, the data 208 and the modules 210 may be stored within the memory 204. In one example, the data 208 may include knowledge artifacts and associated metadata 212, governance index scores 214, business strategies 216, user account information 218, predefined rules 220 and other data 222. In one embodiment, the data 208 may be stored in the memory 204 in the form of various data structures. Additionally, the aforementioned data can be organized using data models, such as relational or hierarchical data models. The other data 222 may be used to store data, including temporary data and temporary files, generated by the modules 210 for performing the various functions of the governance device 102.

The modules 210 may include, for example, the user interface module 108, the knowledge life cycle integrity module 110, the rules engine 112 and the business services module 114. The modules 210 may also comprise other modules 224 to perform various miscellaneous functionalities of the governance device 102. It will be appreciated that such aforementioned modules may be represented as a single module or a combination of different modules.

In operation, the knowledge repository 104 is accessed by one or more users to collaborate on the one or more knowledge artifacts stored therein. In one example, “user” is defined herein specifically, for example, to be a software developer, a line coder, a technical architect, a development lead, or a development manager who is running a team of one or more developers, any of which are working on a software deliverable; or a C-level individual (CIO, CSO, and the like); or an individual that sets or enforces governing standards for software deliverables such as for vulnerability or licensing or knowledge artifacts.

The user interface module 108 is configured to validate a user who wishes to access or collaborate on the one or more knowledge artifacts. In one embodiment, the user interface module 108 receives the login details or the user account information 218 of a user and authenticates the user to access one or more knowledge artifacts based on valid login information. The user is authenticated by comparing the user account information 218 received from the user with login information previously stored at the time of registering the user.

Upon validating the authenticity of the user, the user interface module 108 categorizes or classifies the user into one or more categories including Employee, Supplier, Customer, Investor, and so on. In another embodiment, the user may be categorized as one of Employee—Admin, Employee—and so on. Each categorized user may be assigned with one or more access controls on the one or more knowledge artifacts 212 determined by the rules engine 112. The rules engine 112 may be, for example, the processor 202 configured to determine the one or more access controls based on one or more predefined rules 220 and assign the access controls to the categorized user.

Based on the access controls, the user may access or retrieve the one or more knowledge artifacts and associated metadata 212 from the knowledge repository 104. The term “metadata” is defined to be data that describes the content and context of a file with which the metadata is associated. For example, the metadata associated with a knowledge artifact can indicate a project to which the knowledge artifact belongs, a security of the knowledge artifact or a license that is associated with the knowledge artifact, among other things. The knowledge artifacts and the associated metadata 212 are then processed by the governance device 102 to determine the life cycle integrity of the one or more knowledge artifacts 212.

In one embodiment, the knowledge life cycle integrity module 110 determines scores of the metadata associated with the knowledge artifacts 212 and determines the life cycle integrity index based on the one or more index scores thus determined. The knowledge life cycle integrity module 110 may be implemented by the rules engine 112 or by the processor 202 and memory 204 in the governance device 102. The memory 204 may be operatively connected to the rules engine 112 or to the processor 202 and stores processor-executable instructions to implement the knowledge life cycle integrity module 110. The rules engine 112 determines one or more governance index scores 214 using the metadata of the one or more knowledge artifacts 212 in any sequence or order. One or more governance index scores 214 include a technology governance index score, the process governance index score, and the corporate governance index score.

Technology Governance Index (TGI)

Technology governance index score is a measure of services related to people, processes, technologies involved in the life cycle of the one or more knowledge artifacts. In one implementation, the technology governance index score is determined by the rules engine 112 based on one or more parameter including service level agreement (SLA) compliance, service discoverable ability (DIS), service registry availability (REG), service access control (ACC), and service adaptability (ADA) of the one or more knowledge artifacts 212.

SLA compliance indicates the compliance of the technology management functions on the knowledge repository 104 including Policy definition and Policy Enforcement provision, Service Usage monitoring, Service performance monitoring (for example, response time and mean time between failures (MTBF)), Security monitoring and Identity Management, Integration with LDAP and single sign-on and Security (for example, authentication with Digital certificates and Security Assertion Markup Language (SAML) support). The rules engine 112 determines the compliance of SLA and assigns a score of either ‘0’ or ‘1’ based on the determination. For example, if the rules engine 112 determines that the compliance of technology management functions is met with, then the SLA score is ‘1’, otherwise ‘0’.

DIS indicates the ability of the services on the one or more knowledge artifacts 212 to be discoverable with ease. The available services on the one or more knowledge artifacts 212 should be discoverable in an automated fashion by the rules engine 112 so that the services can be governed. A service delivery protocol will allow automatic detection of these services offered by the knowledge repository 104. The rules engine 112 determines the discoverable ability of the service and assigns a score of either ‘0’ or ‘1’ based on the determination. For example, if the rules engine 112 determines that the service is discoverable with ease, then the DIS score is ‘1’, otherwise ‘0’.

REG is a measure of availability of service registry. A service registry promulgates the universe of available deployed services and the rules for the consumption and invocation. The knowledge repository 104 is configured to manage one or more services and their associated artifacts through their full lifecycle—from planning to development to deployment. Metadata about services will capture information about service interactions and relationships as well as store important related details such as policies, procedures and milestone information. Like other forms of metadata, information and attributes that describe services must be compiled, maintained and stored in a fashion that is consistent, secure and transparent. The rules engine 112 determines the availability of service registry and assigns a score of either ‘0’ or ‘1’ based on the determination. For example, if the rules engine 112 determines that the service registry is available, then the REG score is set ‘1’, otherwise ‘0’.

ACC is an indicative of selective restriction of access to a module or part of the knowledge repository 104 or to specific services. The rules engine 112 determines the establishment of access control for the services and assigns a score of either ‘0’ or ‘1’ based on the determination. For example, if the rules engine 112 determines that the service has access control, then the ACC score is ‘1’, otherwise ‘0’.

ADA is a measure of service adaptability to future change without hit on performance. The acceptance of next-generation Knowledge systems depends to a large extent on the services and applications that can be offered to customers. Tailoring the services to actual user needs is here considered to be crucial for the success of future adaptability for the technology behind the knowledge repository 104. The main features of the future adaptability would include context awareness, personalization, and available infrastructure, current technology adoption and its future roadmap, business services laid out, influence of business consideration on future architectural changes. The rules engine 112 determines the service adaptability to future change without hit on performance and assigns a score of either ‘0’ or ‘1’ based on the determination. For example, if the rules engine 112 determines that the service is adaptable, then the ADA score is ‘1’, otherwise ‘0’.

Based on the computed scores of SLA, DIS, REG, ACC and ADA, the technology governance index score is determined. In one example, the technology governance index score is determined by multiplication factor of SLA, DIS, REG, ACC and ADA as illustrated below:

Technology Governance Index(TGI) score=SLA*DIS*REG*ACC*ADA (1)

The TGI score determined by the rules engine 112 is either ‘0’ or ‘1’, if the TGI score is ‘1’, then the rules engine 112 determines that the one or more knowledge artifacts 212 is eligible for publication, and if the TGI score is ‘0’, then the rules engine 112 determines that the one or more knowledge artifacts 212 is not eligible for publication.

### Process Governance Index (PGI)

Process governance index score is a measure of process maturity of an organization or a part of an organization, ability of organizing the process in the organization, place of organization, predefined roles for organizing the process and so on. In one embodiment, the process governance index is related to existence of a pre-defined business strategy (SBS) behind every knowledge artifact that is created on the knowledge repository 104, compliance of SLAs (RCS) on the process on the one or more knowledge artifacts 212, existence of any agreement on the service re-use (SRU), whether there is any change control board (CMB) that has been established to oversee the change management process and whether the prioritization of knowledge artifacts exists (PKA) etc. In one implementation, the process governance index score is determined by the rules engine 112 based on the scores of SBS, SRU, CMB and RCS.

SBS is an indicative of availability of supporting business strategy in the one or more knowledge artifacts 212. The knowledge repository 104 enables the users or the people of the organization to collaborate on the one or more knowledge artifacts 212 through the user collaboration module 118, and connects the users to expertize. The one or more knowledge artifacts 212 relate to the capital owned by people of the organization and people associated with the organization. The relationship between the strategic direction of a business and the strategic approach to the knowledge repository 104, assumes that there exists collective organizational knowledge that can be managed to encourage the realization of business goals. SBS is indicative of the fact that whether a knowledge artifact is being documented with or without a business strategy. The rules engine 112 determines the availability of a supporting business strategy in the one or more knowledge artifacts 212 and assigns a score of either ‘0’ or ‘1’ based on the determination. For example, if the rules engine 112 determines that supporting business strategy is available, then the SBS score is ‘1’, otherwise ‘0’.

SRU is a measure of availability of agreement on service re-use. SRU is related to a corresponding business value obtained by the development of the service. Service is addressed to one or more activities within multiple enterprise-wide processes and not limited to an activity within a single process. The rules engine 112 determines the availability of agreement on service re-use and assigns a score of either ‘0’ or ‘1’ based on the determination. For example, if the rules engine 112 determines that agreement on service re-use is available, then the SRU score is ‘1’, otherwise ‘0’.

CMB is a body that exists on the one or more knowledge artifacts 212. The CMB comprises one or more members of different stakeholder groups that collaborate with the knowledge repository 104. The CMB is responsible and accountable to consider the views and votes of the one or more members and to define changes control procedures (CCP) for tracking and controlling changes in the one or more knowledge artifacts 212. The CCP defines the process and methods to track and control the changes in the one or more knowledge artifacts 212. In one embodiment, the CCP process and methods are configured to ensure that only approved changes providing business benefit will be undertaken and deployed, to facilitate the evaluation of the impact of changes on the application and its validation status, to maintain the integrity of the application in accordance with document(s) specific to the application and to ensure documentation remains accurate and complete following the release of changes into the production environment. The rules engine 112 determines the existence of CMB and assigns a score of either ‘0’ or ‘1’ based on the determination. For example, if the rules engine 112 determines that CMB exists, then the CMB score is ‘1’, otherwise ‘0’.

RCS defines that relevant laws and regulations are complied by the organizations in achieving the goal of the organizations. Laws and regulations include control methods and procedures that must be in place to secure the integrity of information such as financial information. The control methods and procedures include Vulnerability Assessments, Vendor Security Review, Independent Verification, Vulnerability Scanning and Malicious Code and Backdoor Protection.

Vulnerability Assessment methods enables organizations to identify risks and address application security requirements as part of the software lifecycle process. Vendor Security Review procedures scan Commercial Off-The-Shelf (COTS) applications without requiring access to source code, allowing companies to embed security into their procurement process. Independent Verification methods enable organizations to quickly conduct testing of changes and satisfy “independence” guidelines by providing an independent review and rating. Vulnerability scanning procedures deliver critical services that can be scanned to manage risks associated with vulnerabilities that may impact the integrity of financial reporting. Malicious Code and Backdoor Protection methods allow organizations to assess risks and vulnerabilities in software that handles financial transactions. The rules engine 112 determines the existence of regulatory compliance and assigns a score of either ‘0’ or ‘1’ based on the determination. For example, if it is determined by the rules engine 112 that RCS exists, then the RCS score is ‘1’, otherwise ‘0’.

PKA denotes existence of prioritization of the one or more knowledge artifacts 212. In one embodiment, a governed knowledge artifact with relevant subject matter must be prioritized before a mal-formed knowledge artifact or document so that users can access the well-formed knowledge artifact rather than the mal-formed knowledge artifact. The rules engine 112 determines the existence of prioritization of the one or more knowledge artifacts 212 and assigns a score of either ‘0’ or ‘1’ based on the determination. For example, if the rules engine 112 determines that PKA exists, then the PKA score is ‘1’, otherwise ‘0’.

Based on the computed scores of SBS, SRU, CMB, RCS and PKA, the process governance index score is determined. In one example, the process governance index score is determined by multiplication factor of SBS, SRU, CMB, RCS and PKA as illustrated below:

Process Governance Index(PGI) score=SBS*SRU*CMB*RCS*PKA (2)

The PGI score determined by the rules engine 112 is either ‘0’ or ‘1’, if the PGI score is ‘1’, then the rules engine 112 determines that the one or more knowledge artifacts 212 is eligible for publication, or if the PGI score is ‘0’, then the rules engine 112 determines that the one or more knowledge artifacts 212 is not eligible for publication.

### Corporate Governance Index (CGI)

Corporate governance index determined by the rules engine 112 is an indicative of corporate governance that is a set of processes, customs, policies, laws and institutions affecting the way a corporation is directed, administered or controlled. Corporate governance also includes the relationships among the users involved and the goals for which the corporation is governed. The principal users are for example, the shareholders, management and the board of directors. Other users include employees, suppliers, customers, banks and other lenders, regulators, and the community at large. In one embodiment, the corporate governance index is related to compliance of License (LCI), integrity of audit (AII), availability of proxy advisors (PAI), and transparency in Financial reporting (FRT). In one implementation, the rules engine 112 determines the corporate governance index score based on the scores of LCI, AII, PAI and FRT.

LCI is indicative of compliance of licensing of the one or more knowledge artifacts 212. In one embodiment, the LCI indicates the details of software being installed and details of software licenses being purchased, knowing that installations don't exceed license purchases, details of software being used and software license usage rights & restrictions. LCI is measure of cost reduction while still maintaining compliance on the one or more knowledge artifacts 212. The rules engine 112 determines the compliance of license and assigns a score of either ‘0’ or ‘1’ based on the determination. For example, if the rules engine 112 determines that it is license compliant, then the LCI score is ‘1’, otherwise ‘0’.

AII is a measure of the transparency and reliability of corporate's financial reporting and governance practices. Organizations have external auditors with internal auditors to provide transparency so that information that is being presented has been verified thoroughly. The rules engine 112 determines the presence of external and internal auditors and assigns a score of ‘1’ if there are only internal auditors and assigns ‘2’ if there are both internal and external auditors.

PAI is a measure of availability of proxy advisors. The presence of proxy advisors gives a contra view of the knowledge presented and covers a 360 degree approach to the subject knowledge. The rules engine 112 determines the presence of proxy advisors and assigns a score of either ‘1’ or ‘2’ based on the determination. For example, if the rules engine 112 determines that proxy advisors are present, then the PAI score is ‘2’, otherwise ‘1’.

FRT is indicative of transparency in the financial reporting. Financial reporting on the tradable assets of knowledge artifact must be transparent. The rules engine 112 determines the transparency in the financial reporting and assigns a score of either ‘1’ or ‘2’ based on the determination. For example, if the rules engine 112 determines that there is transparency in the financial reporting, then the FRT score is ‘2’, otherwise ‘1’.

Based on the computed scores of LCI, AII, PAI, and FRT, the corporate governance index score is determined. In one example, the corporate governance index score is determined by multiplication factor of LCI, AII, PAI, and FRT as illustrated below:

Corporate Governance Index(CGI) score=LCI*AII*PAI*FRT (3)

The CGI score determined by the rules engine 112 is any value from 0 to 8. If the CGI score is a non-zero value, then the rules engine 112 determines that the one or more knowledge artifacts 212 is eligible for publication, and if the CGI score is ‘0’, then the rules engine 112 determines that the one or more knowledge artifacts 212 is not eligible for publication.

Upon determining the technology governance index score, the process governance index score and the corporate governance index score in any order, the rules engine 112 determines the future change index score on the one or more knowledge artifacts 212. Prior to determining the future change index score, the rules engine 112 determines the business strategies associated with the one or more knowledge artifacts 212 and evaluates whether any gap exists in the business strategies.

In one embodiment, the rules engine 112 determines the one or more business strategies 216 associated with the one or more knowledge artifacts 212 and compares the one or more determined business strategies 216 with one or more predefined business rules or strategies provided by the business services module 114 coupled with the rules engine 112. If the gap is determined, then the one or more business strategies 216 are analyzed and decomposed by the rules engine 112. Upon analyzing the one or more business strategies 216, the rules engine 112 determines the technology governance index score, the process governance index score and the corporate governance index score in any order. If the rules engine 112 determines a no gap between the one or more business strategies 216, then the rules engine 112 determines the future change index score.

### Future Chance Index (FCI)

The future change index score is indicative of acceptance of next-generation knowledge management systems that depends to a large extent on the services and applications that can be offered to users. Tailoring the services to actual user needs is considered to be crucial for the success of future adaptability for the technology behind the knowledge repository 104. The main features of the future adaptability would include context awareness, personalization, and available infrastructure, current technology adoption and its future roadmap, business services laid out, influence of business consideration on future architectural changes. A measure towards such a future change is the future change index score. The future change index score is determined by the rules engine 112 based on Agility Index score, Talent Index score, Authenticity Index score and Sustainability Index score associated with the one or more knowledge artifacts 212.

Agility index score is a measure of ability of the one or more knowledge artifacts 212 to change efficiently. Agility index score is measured in terms of number of changes that the one or more knowledge artifacts 212 goes through in a predetermined time and the number of users who contribute to such change. Agility index score is determined by the rules engine 112 as illustrated below:

Agility Index(AgI) score=(Σchanges/Σtime taken)*Σusers

Talent Index score is a measure of contribution to the one or more knowledge artifacts 212. Contribution is classified into for example, Reactive contribution, Adaptive contribution and Anticipatory contribution. Reactive contribution is a section of knowledge artifact or document that outlines what has been done in the past and hence what has to be done now, with respect to the context. The section will have more information on examples that have succeeded and/or failed due to adoption of a certain method. Adaptive contribution is a section of the knowledge artifact or document that outlines various risks that currently exist due to the implementation of a current methodology and following a reactive method and tries to create a balance by adapting to the current day technology by mitigating the risk of the older day technology. Anticipatory contribution is a section of the knowledge artifact or a document that outlines the usefulness of the knowledge artifact with respect to a future change. The anticipatory contribution may in turn predict a method of improvement in task efficiency.

Talent index score is determined by the rules engine 112 as illustrated below:

Talent Index(TaI) score=Σusers*(% reactive contribution+% adaptive contribution+% anticipatory contribution)/3

Authenticity Index is a measure of changing content to changing value of money on the tradable knowledge artifacts 212. Authenticity index score is determined by the rules engine 112 as illustrated below:

Authenticity Index(AuI) score=(% Change in trade value of the knowledge artifact)/(% change in content of the knowledge artifact)

Sustainability index is a measure of the life of the knowledge artifact, the number of users accessing the knowledge artifact and the revenues the knowledge artifact could be generating. Sustainability index score is determined by the rules engine 112 as illustrated below:

Sustainability Index(SuI) score=Life of Knowledge Artifact*Σrevenues/Σusers

Based on the computed scores of AgI, TaI, AuI, and SuI, the future change index score is determined by the rules engine 112 as illustrated below:

Future Change Index(FCI) score=AgI*TaI+AuI+SuI (4)

The rules engine 112 further determines the life cycle integrity index score of the one or more knowledge artifacts based on the at least one of technology governance index score, the process governance index score, the corporate governance index score and the future change index score. Lifecycle Integrity Index is a measure of complete lifecycle of the one or more knowledge artifacts 212 encapsulating the technology, relevance, processes and future change potential of the one or more knowledge artifacts 212. In one implementation, the life cycle integrity index score is determined by the rules engine 112 as illustrated below:

Lifecycle Integrity Index=π*(TGI+PGI+CGI+FCI)

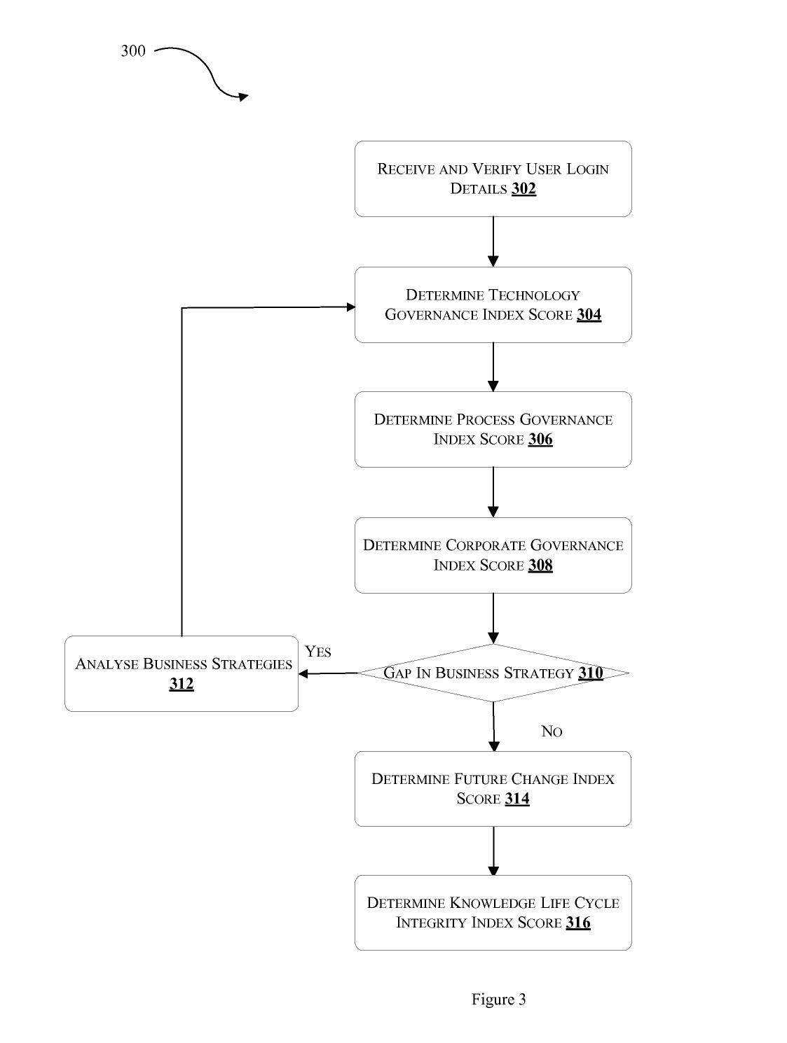

FIG. 3 illustrates a flowchart of method of determining life cycle integrity index score of the knowledge artifacts in accordance with an embodiment of the present disclosure.

As illustrated in FIG. 3, the method 300 comprises one or more blocks implemented by the rules engine 102 for determining life cycle integrity index score of the one or more knowledge artifacts. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

The method 300 relates to determination of life cycle integrity of knowledge artifacts. Let us consider an example, an organization named SocialCools who manufacture refrigerators would like to determine life cycle integrity of related knowledge artifacts. The organization did a research on social and other media and captured data that resulted in identifying that customers were looking forward to buy a Spring Colored refrigerator if available in the market. The organization created a knowledge artifact on what common people think of a Spring Colored refrigerator. According to the organization SocialCools the color of Spring Colored refrigerator is a polymer made from Red, Yellow and Blue colors. The method 300 proceeds with verifying user login details and authorized with one or more access controls to access the Knowledge repository. The user may be for example, Employee at SocialCools.

At block 302, receive and verify user login details. In one embodiment, the user interface module 108 is configured to validate a user who wishes to access or collaborate on the one or more knowledge artifacts. In one embodiment, the user interface module 108 receives the login details or the user account information 218 of a user and authenticates the user to access one or more knowledge artifacts based on valid login information. The users are authenticated by comparing the user account information 218 received from the user with login information previously stored at the time of registering the users. Upon validating the authenticity of the user, the user interface module 108 categorizes or classifies the user into one or more categories. Each categorized user may be assigned with one or more access controls determined by the rules engine 112 on the one or more knowledge artifacts. As per the illustration, the Employee is authenticated and authorized with access controls to publish the knowledge artifact.

At block 304, determine technology governance index score. In one embodiment, the technology governance index score is a measure of services related to people, processes, technologies involved in the life cycle of the one or more knowledge artifacts. In one implementation, the technology governance index score is determined based on service level agreement (SLA) compliance, service discoverable ability (DIS), service registry availability (REG), service access control (ACC), and service adaptability (ADA) of the one or more knowledge artifacts 212.

The rules engine 112 determines the compliance of SLA by determining compliance of the technology management functions and assigns a score of either ‘0’ or ‘1’ based on the determined compliance. In one embodiment, if it is determined by the rules engine 112 that the compliance of SLA is met with, then the SLA score is ‘1’, otherwise ‘0’. For example, the rules engine 112 determines the time taken by the Employee to author the knowledge artifact to set the SLA compliance score since there is no benefit if the knowledge artifact is published late and the manufacturer will not be able to take credible evidence from the market to manufacture the Spring colored refrigerator by Spring season. If the rules engine 112 determines that the Employee takes time more than a predetermined time period predefined by the rules engine 112, then the rules engine 112 sets the SLA score as ‘0’, otherwise ‘1’.

The rules engine 112 further determines the discoverable ability of the service and assigns a score of either ‘0’ or ‘1’ based on the determination. In one embodiment, the rules engine 112 determines that the service is discoverable with ease, then the DIS score is ‘1’, otherwise ‘0’. The service should be discoverable in an automated fashion by the rules engine 112 so that the services can be governed. A service delivery protocol will enable the rules engine 112 to automatically detect the services offered by the knowledge artifact. For example, the knowledge artifact is associated with one or more technology services. Services include displaying the color ‘RED’ of the Spring Colored refrigerator that can be used and that cannot be used. If the rules engine 112 determines that the services are discoverable, i.e., the services have the ability to be searched and retrieved by a Supplier, then sets the DIS score as ‘1’. If there is lack of such service discovery, neither the Supplier nor the customer will be able to genuinely say or comment the RED color that is one of the primary components being used in the polymer to make a spring colored refrigerator. The rules engine 112 sets the DIS score as ‘0’ in case if the service is an undiscoverable service.

The rules engine 112 also determines the availability of service registry and assigns a score of either ‘0’ or ‘1’ based on the determination. In one embodiment, if the rules engine 112 determines the availability of service registry, then the REG score is set ‘1’, otherwise ‘0’. For example, if the service registry is stored with service including the displaying of color RED that can be used and color RED that cannot be used, then the rules engine 112 sets the REG score as ‘1’, otherwise as ‘0’.

The rules engine 112 further determines the establishment of access control for the services and assigns a score of either ‘0’ or ‘1’ based on the determination. In one embodiment, if the rules engine 112 determines that the service has access control, then the ACC score is ‘1’, otherwise ‘0’. For example, if the Employee at SocialCools who is the author of the knowledge artifact publishes the knowledge artifact without validating the consequence of publishing the information without SocialCools authorization. Then the rules engine 112 sets the ACC score as ‘0’ based on predefined rules that define one or more access controls for the knowledge artifact, otherwise as ‘1’.

The rules engine 112 furthermore determines the service adaptability to future change without hit on performance and assigns a score of either ‘0’ or ‘1’ based on the determination. In one embodiment, if the rules engine 112 determines that the service is adaptable, then the ADA score is ‘1’, otherwise ‘0’. For example, the knowledge artifact of SocialCools uses a technology to arrive at the polymer of Spring Colored refrigerator that is not scalable in future. If the rules engine 112 determines the limited scope in the product output capability and non-scalability feature, then the rules engine 112 sets the ADA score as ‘0’, otherwise as ‘1’.

Based on the computed scores of SLA, DIS, REG, ACC and ADA, the technology governance index score is determined. In one example, the technology governance index score is determined by multiplication factor of SLA, DIS, REG, ACC and ADA as illustrated below:

Technology Governance Index(TGI) score=SLA*DIS*REG*ACC*ADA.

The TGI score determined by the rules engine 112 is either ‘0’ or ‘1’, if the TGI score is ‘1’, then the rules engine 112 determines that the one or more knowledge artifacts 212 is eligible for publication, and if the TGI score is ‘0’, then the rules engine 112 determines that the one or more knowledge artifacts 212 is not eligible for publication.

At block 306, determine process governance index score. In one embodiment, the process governance index score is determined based on existence of a pre-defined business strategy (SBS) behind every knowledge artifact that is getting created on the knowledge repository 104, compliance of SLAs (RCS) on the process on the one or more knowledge artifacts 212, existence of any agreement on the service re-use (SRU), whether there is any change control board (CMB) that has been established to oversee the change management process and whether the prioritization of knowledge artifacts exists (PKA) etc. In one implementation, the process governance index score is determined by the rules engine 112 based on the scores of SBS, SRU, CMB and RCS.

The rules engine 112 determines the availability of a supporting business strategy in the one or more knowledge artifacts 212 and assigns a score of either ‘0’ or ‘1’ based on the determination. In one embodiment, if the rules engine 112 determines that supporting business strategy is available, then the SBS score is ‘1’, otherwise ‘0’. For example, if the rules engine 112 determines that the knowledge artifact related to the polymer of the Spring colored refrigerator is supported with a business strategy, then the SBS score is set as ‘1’, otherwise as ‘0’.

The rules engine 112 further determines the availability of agreement on service re-use and assigns a score of either ‘0’ or ‘1’ based on the determination. In one embodiment, if the rules engine 112 determines that agreement on service re-use is available, then the SRU score is ‘1’, otherwise ‘0’. For example, if the rules engine 112 determines that the agreement on re-use of service i.e., displaying the color that can be used and that cannot be used is available, then the SBS score is set as ‘1’, otherwise as ‘0’.

The rules engine 112 also determines the existence of CMB and assigns a score of either ‘0’ or ‘1’ based on the determination. In one embodiment, if the rules engine 112 determines that CMB exists, then the CMB score is ‘1’, otherwise ‘0’. For example, if the rules engine 112 determines the existence of CMB for the knowledge artifact related to polymer of the Spring Colored refrigerator, then the CMB score is ‘1’ or ‘0’.

The rules engine 112 further determines the existence of regulatory compliance and assigns a score of either ‘0’ or ‘1’ based on the determination. In one embodiment, if the rules engine 112 determines that RCS exists, then the RCS score is ‘1’, otherwise ‘0’. The rules engine 112 furthermore determines the existence of prioritization of the one or more knowledge artifacts 212 and assigns a score of either ‘0’ or ‘1’ based on the determination. For example, if the rules engine 112 determines that PKA exists, then the PKA score is ‘1’, otherwise ‘0’.

Based on the computed scores of SBS, SRU, CMB, RCS and PKA, the process governance index score is determined. In one example, the process governance index score is determined by multiplication factor of SBS, SRU, CMB, RCS and PKA as illustrated below:

Process Governance Index(PGI) score=SBS*SRU*CMB*RCS*PKA

The PGI score determined by the rules engine 112 is either ‘0’ or ‘1’, if the PGI score is ‘1’, then the rules engine 112 determines that the one or more knowledge artifacts 212 is eligible for publication, and if the PGI score is ‘0’, then the rules engine 112 determines that the one or more knowledge artifacts 212 is not eligible for publication.

At block 308, determine corporate governance index score. In one implementation, the corporate governance index is related to compliance of License (LCI), integrity of audit (AII), availability of proxy advisors (PAI), and transparency in Financial reporting (FRT). In one implementation, the rules engine 112 determines the corporate governance index score based on the scores of LCI, AII, PAI and FRT.

The rules engine 112 determines the compliance of license and assigns a score of either ‘0’ or ‘1’ based on the determination. In one embodiment, if the rules engine 112 determines that it is license compliant, then the LCI score is ‘1’, otherwise ‘0’. For example, if the rules engine 112 determines that the knowledge artifact of polymer for Spring Colored refrigerator is license compliant, then the LCI score is set as ‘1’, otherwise as ‘0’. The rules engine 112 further determines the presence of external and internal auditors and assigns a score of ‘1’ if there are only internal auditors and assigns ‘2’ if there are both internal and external auditors. The rules engine 112 also determines the presence of proxy advisors and assigns a score of either ‘1’ or ‘2’ based on the determination. For example, if the rules engine 112 determines that proxy advisors are present, then the PAI score is ‘2’, otherwise ‘1’. The rules engine 112 furthermore determines the transparency in the financial reporting and assigns a score of either ‘1’ or ‘2’ based on the determination. For example, if the rules engine 112 determines that there is transparency in the financial reporting, then the FRT score is ‘2’, otherwise ‘1’.

Based on the computed scores of LCI, AII, PAI, and FRT, the corporate governance index score is determined. In one example, the corporate governance index score is determined by multiplication factor of LCI, AII, PAI, and FRT as illustrated below:

Corporate Governance Index(CGI) score=LCI*AII*PAI*FRT

The CGI score determined by the rules engine 112 is any value from 0 to 8. If the CGI score is a non-zero value, then the rules engine 112 determines that the one or more knowledge artifacts 212 is eligible for publication, and if the CGI score is ‘0’, then the rules engine 112 determines that the one or more knowledge artifacts 212 is not eligible for publication.

At block 310, it is determined as to whether there is a gap in business strategy. In one implementation, upon determining the technology governance index score, the process governance index score and the corporate governance index score in any order, the rules engine 112 determines the business strategies associated with the one or more knowledge artifacts 212 and evaluates whether any gap exists in the business strategies. In one embodiment, the rules engine 112 determines the one or more business strategies 216 associated with the one or more knowledge artifacts 212 and compares the one or more determined business strategies 216 with one or more predefined business rules or strategies provided by the business services module 114 coupled with the rules engine 112. If the gap is determined, then the method 300 proceeds to block 312 along the “YES” path; otherwise proceeds to block 314 along the “NO” path. For example, if the business strategies related to the knowledge artifact of polymer of the Spring Colored refrigerator is determined to have gap, i.e., the business strategies in terms of polymer is compared against industry standard expertize, then the rules engine 112 determines a gap based on the comparison and sets the score as ‘1’ or ‘0’.

At block 312, analyse business strategies. In one implementation, if it is determined that there is a gap in the business strategies 216 along the “YES” path, then the rules engine 112 analyses the one or more business strategies 216. Upon analyzing the one or more business strategies 216, the rules engine 112 determines the technology governance index score, the process governance index score and the corporate governance index score in any order.

At block 314, determine future change index score. In one implementation, if the rules engine 112 determines that there is no gap between the one or more business strategies 216 along the “NO” path, then the rules engine 112 determines the future change index score. The future change index score is determined by the rules engine 112 based on Agility Index score, Talent Index score, Authenticity Index score and Sustainability Index score associated with the one or more knowledge artifacts 212.

Agility index score is a measure of ability of the one or more knowledge artifacts 212 to change efficiently. Agility index score is measured in terms of number of changes that the one or more knowledge artifacts 212 goes through in a predetermined time and the number of users who contribute to such change. For example, the rules engine 112 determines the agility index score of the knowledge artifact related to polymer of Spring Colored refrigerator based on the number of changes made by the Employee and time taken for the changes. Agility index score is determined by the rules engine 112 as illustrated below:

Agility Index(AgI) score=(Σchanges/Σtime taken)*Σusers

Talent Index score is a measure of contribution to the one or more knowledge artifacts 212. For example, the rules engine 112 determines the talent index score of the knowledge artifact related to polymer of Spring Colored refrigerator based on contribution by the Employee, etc. Talent index score is determined by the rules engine 112 as illustrated below:

Talent Index(TaI) score=Σusers*(% reactive contribution+% adaptive contribution+% anticipatory contribution)/3

Authenticity Index is a measure of changing content to changing value of money on the tradable knowledge artifacts 212. For example, the rules engine 112 determines the authenticity index score of the knowledge artifact related to polymer of Spring Colored refrigerator based on change in trade value of the knowledge artifact. Authenticity index score is determined by the rules engine 112 as illustrated below:

Authenticity Index(AuI) score=(% Change in trade value of the knowledge artifact)/(% change in content of the knowledge artifact)

Sustainability index is a measure of the life of the knowledge artifact, the number of users accessing the knowledge artifact and the revenues the knowledge artifact could be generating. For example, the rules engine 112 determines the sustainability index score of the knowledge artifact related to polymer of Spring Colored refrigerator based on the life of the knowledge artifact, revenues and users including Employee. Sustainability index score is determined by the rules engine 112 as illustrated below:

Sustainability Index(SuI) score=Life of Knowledge Artifact*Σrevenues/Σusers

Based on the computed scores of AgI, TaI, AuI, and SuI, the future change index score is determined by the rules engine 112 as illustrated below:

Future Change Index(FCI) score=AgI*TaI+AuI+SuI

At block 316, determine knowledge life cycle integrity index score. In one implementation, the rules engine 112 further determines the life cycle integrity index score of the one or more knowledge artifacts based on the at least one of technology governance index score, the process governance index score, the corporate governance index score and the future change index score. Lifecycle Integrity Index is a measure of complete lifecycle of the one or more knowledge artifacts 212 encapsulating the technology, relevance, processes and future change potential of the one or more knowledge artifacts 212. In one embodiment, the life cycle integrity index score is determined by the rules engine 112 as illustrated below:

Lifecycle Integrity Index=π*(TGI+PGI+CGI+FCI)

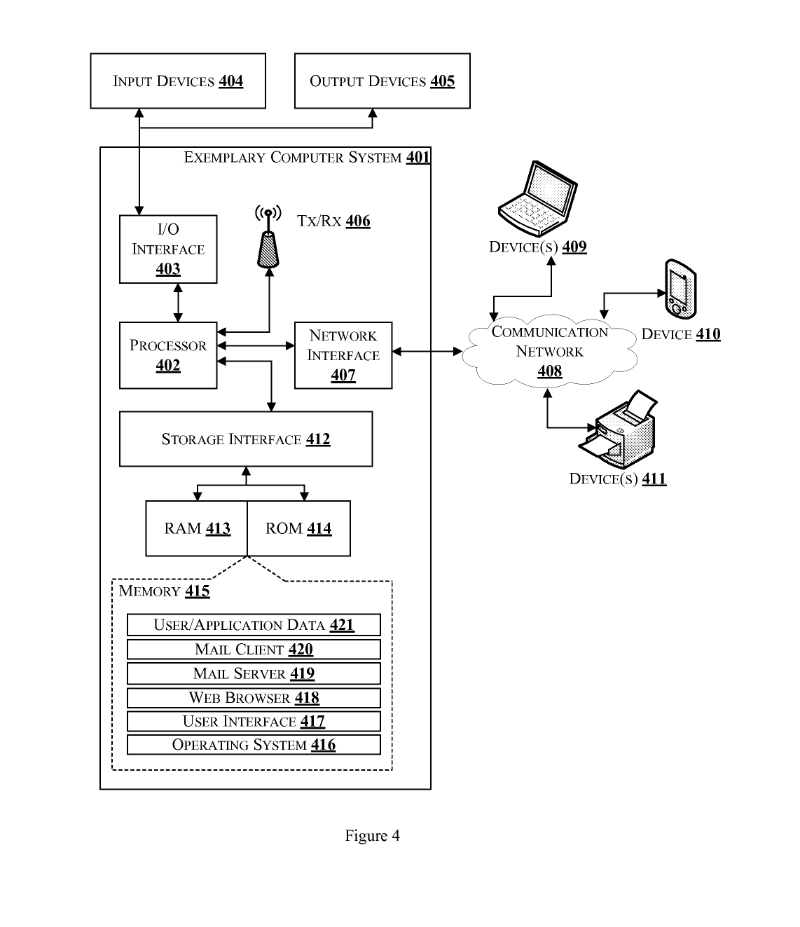

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 402. Processor 402 may comprise at least one data processor for executing program components for executing user- or system-generated requests. The processor may include specialized processing units such as integrated system (bus) controllers, memory management control units, floating point units, graphics processing units, digital signal processing units, etc. The processor 402 may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 4Error! Reference source not found.14, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 415 may store a collection of program or database components, including, without limitation, an operating system 4Error! Reference source not found.16, user interface application 4Error! Reference source not found.17, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As described above, the modules 210, amongst other things, include routines, programs, objects, components, and data structures, which perform particular tasks or implement particular abstract data types. The modules 210 may also be implemented as, signal processor(s), state machine(s), logic circuitries, and/or any other device or component that manipulate signals based on operational instructions. Further, the modules 210 can be implemented by one or more hardware components, by computer-readable instructions executed by a processing unit, or by a combination thereof.

The specification has described a method and a system for determining lifecycle integrity of knowledge artifacts. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of determining a lifecycle integrity of one or more knowledge artifacts comprising:
obtaining, by a knowledge management computing device, at least one metadata associated with the one or more knowledge artifacts;
determining, by the knowledge management computing device, at least one of a technology governance index score, a process governance index score, a corporate governance index score, or a future change index score using the at least one metadata of the one or more knowledge artifacts; and
determining, by the knowledge management computing device, a life cycle integrity index score of the one or more knowledge artifacts based on the at least one of technology governance index score, the process governance index score, the corporate governance index score or the future change index score.

2. The method as set forth in claim 1, wherein the technology governance index score is determined based on one or more parameters comprising a Service Level Agreement (SLA) compliance score, a service discoverable ability score, a service registry availability score, a service access control score, or a service adaptability score of the one or more knowledge artifacts.

3. The method as set forth in claim 1, wherein the process governance index score is determined based on one or more parameters comprising a supporting business strategy availability score, a service re-use agreement availability score, a change management board existence score, a regulatory compliance score, or a prioritization score of the one or more knowledge artifacts.

4. The method as set forth in claim 1, wherein the corporate governance index score is determined based on one or more parameters comprising a licensing compliance score, an audit integrity score, a proxy advisors availability score, or a financial reporting transparency score of the one or more knowledge artifacts.

5. The method as set forth in claim 1, wherein determining the technology governance index score, the process governance index score or the corporate governance index score comprises:
determining, by the knowledge management computing device, a gap between one or more business strategies associated with the one or more knowledge artifacts;
analyzing, by the knowledge management computing device, the one or more business strategies based on the gap determining; and
determining, by the knowledge management computing device, at least one of the technology governance index score, the process governance index score or the corporate governance index score based on the analyzing.

6. The method as claimed in claim 5, wherein determining the gap between the one or more business strategies comprises:
determining, by the knowledge management computing device, one or more business strategies associated with the one or more knowledge artifacts;
comparing, by the knowledge management computing device, the one or more determined business strategies with one or more pre-defined rules associated with the one or more knowledge artifacts; and
determining, by the knowledge management computing device, the gap between the one or more determined business strategies and the one or more pre-defined rules based on the comparing.

7. The method as claimed in claim 1, wherein the future change index score is determined based on one or more parameters comprising an agility index score, a talent index score, an authenticity index score or a sustainability index score of the one or more knowledge artifacts.

8. The method as claimed in claim 1, wherein obtaining the at least one metadata comprises:
receiving, by the knowledge management computing device, user information from a user;
determining, by the knowledge management computing device, a validity of the received user information by comparing the received user information with user information previously stored in a knowledge repository; and
providing, by the knowledge management computing device, one or more access control rights to the user for accessing the knowledge repository based on the validity determining.

9. A knowledge management computing device comprising:
a processor coupled to a memory and configured to execute programmed instructions stored in the memory, comprising:
obtaining at least one metadata associated with one or more knowledge artifacts;
determining at least one of a technology governance index score, a process governance index score, a corporate governance index score, or a future change index score using the at least one metadata of the one or more knowledge artifacts; and
determining a life cycle integrity index score of the one or more knowledge artifacts based on the at least one of technology governance index score, the process governance index score, the corporate governance index score or the future change index score.

10. The device as set forth in claim 9, wherein the technology governance index score is determined based on one or more parameters comprising a Service Level Agreement (SLA) compliance score, a service discoverable ability score, a service registry availability score, a service access control score, or a service adaptability score of the one or more knowledge artifacts.

11. The device as set forth in claim 9, wherein the process governance index score is determined based on one or more parameters comprising a supporting business strategy availability score, a service re-use agreement availability score, a change management board existence score, a regulatory compliance score, or a prioritization score of the one or more knowledge artifacts.

12. The device as set forth in claim 9, wherein the corporate governance index score is determined based on one or more parameters comprising a licensing compliance score, an audit integrity score, a proxy advisors availability score, or a financial reporting transparency score of the one or more knowledge artifacts.

13. The device as set forth in claim 9, wherein determining the technology governance index score, the process governance index score or the corporate governance index score comprises:
determining a gap between one or more business strategies associated with the one or more knowledge artifacts;
analyzing the one or more business strategies based on the gap determining; and
determining at least one of the technology governance index score, the process governance index score or the corporate governance index score based on the analyzing.

14. The device as set forth in claim 13, wherein determining the gap between the one or more business strategies comprises:
determining one or more business strategies associated with the one or more knowledge artifacts;
comparing the one or more determined business strategies with one or more pre-defined rules associated with the one or more knowledge artifacts; and
determining the gap between the one or more determined business strategies and the one or more pre-defined rules based on the comparing.

15. The device as set forth in claim 9, wherein the future change index score is determined based on one or more parameters comprising an agility index score, a talent index score, an authenticity index score or a sustainability index score of the one or more knowledge artifacts.

16. The device as set forth in claim 9, wherein obtaining the at least one metadata comprises:
receiving, by the knowledge management computing device, user information from a user;
determining, by the knowledge management computing device, a validity of the received user information by comparing the received user information with user information previously stored in a knowledge repository; and
providing, by the knowledge management computing device, one or more access control rights to the user for accessing the knowledge repository based on the validity determining.

17. A non-transitory computer readable medium having stored thereon instructions for determining a lifecycle integrity of one or more knowledge artifacts comprising machine executable code which when executed by a processor, causes the processor to perform steps comprising:
obtaining at least one metadata associated with one or more knowledge artifacts;
determining at least one of a technology governance index score, a process governance index score, a corporate governance index score, or a future change index score using the at least one metadata of the one or more knowledge artifacts; and
determining a life cycle integrity index score of the one or more knowledge artifacts based on the at least one of technology governance index score, the process governance index score, the corporate governance index score or the future change index score.

18. The medium as set forth in claim 17, wherein the technology governance index score is determined based on one or more parameters comprising a Service Level Agreement (SLA) compliance score, a service discoverable ability score, a service registry availability score, a service access control score, or a service adaptability score of the one or more knowledge artifacts.

19. The medium as set forth in claim 17, wherein the process governance index score is determined based on one or more parameters comprising a supporting business strategy availability score, a service re-use agreement availability score, a change management board existence score, a regulatory compliance score, or a prioritization score of the one or more knowledge artifacts.

20. The medium as set forth in claim 17, wherein the corporate governance index score is determined based on one or more parameters comprising a licensing compliance score, an audit integrity score, a proxy advisors availability score, or a financial reporting transparency score of the one or more knowledge artifacts.

21. The medium as set forth in claim 17, wherein determining the technology governance index score, the process governance index score or the corporate governance index score comprises:
determining a gap between one or more business strategies associated with the one or more knowledge artifacts;
analyzing the one or more business strategies based on the gap determining; and
determining at least one of the technology governance index score, the process governance index score or the corporate governance index score based on the analyzing.

22. The medium as set forth in claim 21, wherein determining the gap between the one or more business strategies comprises:
determining one or more business strategies associated with the one or more knowledge artifacts;
comparing the one or more determined business strategies with one or more pre-defined rules associated with the one or more knowledge artifacts; and
determining the gap between the one or more determined business strategies and the one or more pre-defined rules based on the comparing.

23. The medium as set forth in claim 17, wherein the future change index score is determined based on one or more parameters comprising an agility index score, a talent index score, an authenticity index score or a sustainability index score of the one or more knowledge artifacts.

24. The medium as set forth in claim 17, wherein obtaining the at least one metadata comprises:
receiving, by the knowledge management computing device, user information from a user;
determining, by the knowledge management computing device, a validity of the received user information by comparing the received user information with user information previously stored in a knowledge repository; and
providing, by the knowledge management computing device, one or more access control rights to the user for accessing the knowledge repository based on the validity determining.
